(19) United States
(12) Patent Application Publication
(10) Pub. No.: US 2008/0047192 A1
(43) Pub. Date: Feb. 28, 2008

(54) Fishhook

(76) Inventor: Gary Bennis, Eau Claire, WI (US)

Correspondence Address: Carl L. Johnson;Jacobson and Johnson, Suite 285, One West Water Street, St. Paul, MN, 55107-2080, US

(21) Appl. No.: 11/511,031

(22) Filed: Aug. 28, 2006

(51) Int. Cl. A01K 83/06; A01K 83/00

(52) U.S. Cl. 43/44.8; 43/44.2; 43/43.16

(57) ABSTRACT

An improved fishhook that inhibits or maintain live bait on the bend of the fishhook as well as inhibiting or preventing a fish from “throwing the hook”. To retain live bait, such as a minnow, on the bend of the fishhook a bend stop can be used in conjunction with the bend stop to form a bait confiner to limit the travel of the live bait along the length of the fishhook thus enhancing the ability of a bait fish such as minnow to be presented in an attractive condition on the bend of the fishhook. Also to inhibit a fish from throwing the hook, the conventional sharp edges of the barb can be rounded. While the inhibiting features of bend stops or round edge barbs can be used individually they can also be used in combination to provide a fishhook with enhanced inhibiting characteristics.

### FIELD OF THE INVENTION

This invention relates generally to fishhooks and more specifically to an inhibitor fishhook that confines the bait and inhibits a fish from “throwing the hook”.

### CROSS REFERENCE TO RELATED APPLICATIONS

None

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

Generally fishhooks contain three main regions, a shank with an eye for attaching a fishing line thereto, a bend that curvedly connects the shank to the front length, which contains a sharp barb and a point, with the distance from the bottom of the bend to the point known as the bite/throat. When fishing with live bait, such as a minnow, the point of the fishhook is inserted through the skin on the back of the minnow thus forming a fishhook hole in the minnow's skin. This does not kill the minnow but allows the minnow to generate a swimming motion while held on the fishhook to thereby entice fish to bite the minnow. When so attached the minnow oftentimes swim sideways onto the front length of the fishhook which is proximate the barb. The minnow can then lay on its side and resist being submerged especially if the fisherperson uses a light weight line or a light weight sinker. While the barb is for the purpose of making it difficult for the minnow or the fish to get off the fishhook, unfortunately, as the minnow rides up against the barb it can also injure or tear the minnow's skin thereby enlarging the fishhook hole in the minnow's skin. With an enlarged fishhook hole it is easier for the minnow to slide over the barb and off the fishhook all because the minnow was able to leave the bite/throat region of the fishhook and move into the front length of the fishhook where the minnow can enlarge or tear the fishhook hole with the barb.

Oftentimes the fisherperson doesn't notice that the minnow is on the front length of his or her fishhook, especially if one casts the fish rig far away from the boat. Also a fisherperson adds sinkers to a fishing line by placing weights, usually about 12 to 18 inches above the fishhook, which causes the fishhook and minnow to immediately submerge when the fishhook and weights hit the water thereby limiting a fisherpersons observation of the location of the minnow on the fishhook. When the fisherperson reels up the line the fisherperson discovers that there is no minnow on the fishhook since the minnow has been able to free itself from the fishhook using the sharp point on the barb to cut the flesh of the minnow. The present invention provides an improved fishhook that inhibits the tendency of a minnow to free itself from the fishhook and by carrying the live bait in a more friendly and natural position.

The problem also occurs with fishhooks having rounded barbs such as shown in Perez U.S. Pat. No. 6,289,628 as well as barbless fishhooks since it is easier for the minnow to slip completely off the fishhook if there is no barb to impede the minnow from sliding. That is, once the minnow gets on the front length of the fishhook and out of the bend of the fishhook it becomes easier for the minnow to slip off the end of the fishhook since the minnow can slide unimpeded straight off the end of the fishhook. The present invention provides an improved fishhook that inhibits or prevents a minnow from sliding off the fishhook even if the fishhook is barbless.

Another problem that occurs with conventional fishhooks is that once the fish is caught it can free itself by a process called “throwing the fishhook”. Typically, when a fisherperson has a successful day of fishing he or she may tell others “I caught a bunch of fish”. They don't point out how the fish was hooked but simply say “I caught a bunch of fish.” Fish can be snagged, which isn't often, but most fish are caught by a hook which is either in the gullet, which is at the back of the throat, the roof of the mouth or the lip. In general, most fish are caught on the lip. Just behind the lip of the fish is a soft lining of flesh that gets penetrated by the point of the fishhook as the fisherperson sets the hook. When the fishhook is set the point of the fishhook penetrates the lip as the lip of the fish is pulled onto the bend into the bite/throat area of the hook. Once the fishhook is set most fish start to struggle. As the fish struggles the lip of the fish can easily enter the front length of the fishhook where it engages the sharp barb, which can cut or tear the soft flesh thus enhancing the ability of the fish to “throw the hook” and escape being caught. If the fishhook is barbless the fish can more easily slide off the fishhook since there is nothing to impede the fish from sliding off the fishhook as the fish darts about. The present invention provides a fishhook that inhibits a fish from “throwing the hook”.

### SUMMARY OF THE INVENTION

Briefly, the present invention comprises an inhibitor fishhook. In one embodiment a bend stop inhibits or maintains live bait on the bend of the fishhook as well as inhibiting or preventing a fish from “throwing the hook”. To inhibit live bait from sliding off the bend of a hook, such as a minnow, opposing bend stops can be used in conjunction to limit the travel of the live bait along the length of the fishhook thus enhancing the ability of the minnow to remain in an attractive condition on the bend of the fishhook. Also to inhibit a fish from throwing the hook, the conventional sharp edges of the barb can be rounded. While the inhibiting features of bend stops or round edge barbs can be used individually they can also be used in combination to provide a fishhook with enhanced inhibiting characteristics.

### BRIEF DESCRIPTION OF THE DRAWINGS

FIG. 1 is side view of a fishhook with a stop;

FIG. 1A is a cross sectional view take along lines A-A of FIG. 1;

FIG. 2 is a side view of a fishhook with a cone shaped stop;

FIG. 3 is a side view of a fishhook with a spherical shaped stop;

FIG. 4 is a side view of a barbless fishhook with a confiner thereon;

FIG. 4A is an enlarged view of a bend stop of FIG. 4;

FIG. 5 is an enlarged view of a head of a fish hook of FIG. 1; and

FIG. 6 is a partial sectional view of a non-cutting barb on the head of the fishhook of FIG. 1.

### DESCRIPTION OF THE PREFERRED EMBODIMENT

Conventional fishhooks generally have a shank, which can be curved or straight, with an eye for tying a line thereto, a bend for retaining the bait or the fish and a front length with a head having a point and a barb for piercing the bait or the fish. Still other hooks have no barbs or multiple barbs on the head of the hook.

FIG. 1 shows a side view of a one-piece barbed fishhook 10 having an elongated cylindrical straight shank 12 with an eye 11 formed thereon for engaging a fishing line. Shank 12 has a length designated by L, a bend or curved portion 13, which is designated by B, and a front length designated by FL. Front length FL includes a head H and a portion of the bend B. The head H includes a point or tip 14 and a barb 15 with the H located at the end of the bend B. Shank 12 has a diameter designated by D₁ with the fishhook formed from a single piece of wire. Generally, fishhooks are made from a wire or the like and are bent into a J-shape with one end formed into the eye and the other end formed into a head with a point, sometimes with a barb and other times without a barb.

In the embodiment shown in FIG. 1 the bend 13 of the fishhook has been modified by grinding to include a shank facing bend stop 13b and a point facing bend stop 13a with the surface distance between stops denoted by the X with the bend stop 13a and 13b extending radially inward toward a radius of curvature of the bend. The embodiment of FIG. 1 is well suited for manufacture by grinding away unwanted portions of the wire to thereby form a fishhook with integral stops.

FIG. 1 shows the fishhook 10 has a front length with the front length FL and the bend B overlapping each other with the bend stop 13b located on the overlapping region of the front length FL and the bend B with the bend stop 13b located proximate the head H to inhibit or prevent bait from sliding off the hook. Bend stop 13b is designed to impede the bait or a lip of a caught fish from sliding therepast without tearing the flesh of a fish like occurs with a conventional barb. Bend stop 13a is particularly useful in preventing live bait such as leeches from sliding up the shank 12.

While fishhooks with various cross sectional shapes can be used, fishhook shank 12 has a circular cross section with a diameter D₁ and with an inner radial portion of bend 13 which has been removed by grinding or the like to form the bend stop 13b and the bend stop 13a. FIG. 1A shows a cross sectional view of the fishhook taken along lines A-A showing a top hemispherical portion of the fishhook has been removed to leave a lower hemispherical portion 13 of dimension Y₁ that extends a distance X along the bend B with a surface 13a extending upward forming a bend stop 13a. That is, the removal of an inner radial portion of the bend B by grinding or the like creates a bend stop 13a to inhibit the bait fish such as a minnow or the like from moving onto the shank 12 and a bend stop 13b to prevent the bait fish from leaving the bend B of the fishhook 10. In this embodiment the diameter of the fishhook can be reduced to provide a region on the bend for confining bait in an active upright condition. Thus, the use of the two bend stops, which face each other and are located on the bend of the hook, forms a bait confiner 13c that can confine bait in a bait confining region located between the bend stops on the bend of the fishhook. A further feature of the invention is that the bait confiner 33 can comprise a contrasting color or finish with the rest of the hook. The use of a contrasting color allows the fisherperson to more easily select the fishhook from his or her fishing box. In addition contrasting the bait container 13c with the rest of the fishhook 10 provides the fisherperson with a visual indication of the permitted limits of movement of the bait on the hook. In some instance the bait confiner 13c can extend a short distance along the bend B while in other embodiments the bait confiner 13c can extend a longer distance along the bend B. By providing a visual distinction of the bait confiner 13c on the fishhook the fisherperson can quickly select the fishhook with the proper length bait confiner. For example, the bait confiner 13, as shown in FIG. 1, has a cross section area that is less than the cross section area of the shank of the fishhook and the bait confiner can be visually distinguishable from the rest of the fishhook by color as well as by shape.

Although two stops are used to confine bait in a selected portion of the bend of the fishhook a feature of the invention is that a single shank facing stop located proximate the head H of the fishhook 12 can be used as both a stop to inhibit or prevent bait from sliding off the fishhook as well as inhibiting or preventing fish caught on the fishhook from sliding off the fishhook or “throwing the hook”. That is, in some instance one might not be concerned with bait sliding up the shank or confining the bait to a bait confining region but one might be more concerned with a caught fish sliding off the fishhook i.e. “throwing the hook”. By providing a stop 13b in conjunction with a head H having a barb 15 one makes it more difficult for a fish to throw the fishhook since the stop 13b maintains the lip of the fish on the bend of the fishhook where it is more difficult for the fish to throw the hook. In one embodiment the barb 15 and the stop 13b are of the same dimension so as to have stop 13b provide a first resistance to a fish throwing the hook and barb 15 providing a second equal resistance to a fish throwing the hook.

Referring to FIG. 1, located on the bend B of the fishhook and spaced from the barb 15 is a bend stop 13b that inhibits or prevents bait such as minnows, leeches and the like from sliding off the fishhook as well as inhibiting a caught fish from slipping off the hook. As pointed out, bend stop 13b inhibits bait, such as a minnow, from sliding off the bend B and up to the barb 15 on the head H of the fishhook 10 where the barb 15 can tear or cut the minnow or the like. By having stop 13b positioned on the bend B so that a minnow or the like is retained from accessing the head H one can inhibit the minnow from slipping off the hook. That is, it is preferred to retain the minnow on the lower portion of the bend B of the fishhook 10 since it makes it more difficult for a minnow to slide off the pointed end of the fishhook 10. While stop 13b inhibits a minnow from sliding off the fishhook it provides a dual purpose in that stop 13b also inhibits a fish, once caught on the fishhook from freeing itself from the hook. In fisherperson's terminology when a fish frees itself from the fishhook by thrashing about it is referred to as “throwing the hook”. Stop 13b inhibits a fish from “throwing the hook” by inhibiting or preventing the lip of the fish from slipping off the bend B and onto the head H of the fishhook 10. Thus, a fishhook with a single bend stop, such as illustrated in FIG. 4, can be used to inhibit or prevent a fish from “throwing the hook” as well as inhibiting or preventing bait such as a minnow or fish from slipping off the end of the fishhook by providing an impediment on the bend B of the fishhook.

FIG. 1 shows bend stop 13b located on the bend portion B of fishhook 10 with bend stop 13b spaced from the barb 15 of the hook. By keeping a minnow on the lower portion of the bend B (designated by X) of the fishhook 10 and away from the head H of the fishhook where the barb 15 and point 14 are located makes it more difficult for the minnow to slip off the fishhook 10 since the minnow has to rotate 90 degrees to get from the bait confiner region 13 to the straight portion of the front length FL. Consequently, even if the fishhook is barbless having the bend stop 13b on a curved portion of the bend proximate the head H can inhibit a minnow from slipping off the hook.

Referring to FIG. 1, when bend stop 13b is used in conjunction with a second bend stop 13a the two stops coact to provide a bait confining region therebetween that inhibits a minnow from moving from the bend portion of the fishhook up to the barb on the head H where the minnow can free itself through engagement with the barb 15. In addition the bend stop 13a inhibits the live bait such as minnow or leeches from sliding onto the shank 12. Also by retaining a minnow in the bait-confining region 13 one increases the likelihood that when a fish bites the minnow the point of the fishhook will pierce the lip of the fish. Thus when a shank facing bend stop 13b and a point facing bend stop 13a are used in conjunction it not only inhibits or prevents a minnow from slipping toward the point 14 but it also inhibits or prevents the minnow on the fishhook from sliding up the shank 12. Consequently, the minnow is confined in an upright natural swimming condition with the back of the minnow secured in the bait confining region 13 on the fishhook 10, which is more likely to provide a presentation that will induce a fish to bite. While a one-piece fishhook has been described the invention could be used with fishhooks made from multiple parts or could be used in other types of hooks including treble hooks or the like.

To illustrate a fishhook with a single bend stop reference should be made to FIG. 4, which shows an embodiment having a single bend stop as well as a barbless fishhook 40. In this embodiment a cone shaped protrusion 48 has been formed in the bend of the fishhook 40. The protrusion on the fishhook can be formed in a number or ways for example, by cold forming or by press fitting a collar onto the fishhook.

Fishhook 40 has a shank 42 with an eye 41 located at one end of shank 42. Located on bend 43 of fishhook 40 is bend stop 48 that comprises a cone shaped protrusion. A reference to FIG. 4A shows that the cone shaped bend stop 48 has a diameter D₃ that is larger than the diameter D₁ of the rest of the body of fishhook 40. FIG. 4 shows bend stop 48 is located on the bend portion 43 and spaced from the point 44 a distance L₂ where L₂ is sufficiently long so as to bring the bend stop onto the bend of the fishhook. As a result both a bait which is mounted on fishhook 40 and a fish that is caught on fishhook 40 are inhibited or prevented from sliding off the fishhook by the shank facing surface 48a of bend stop 48.

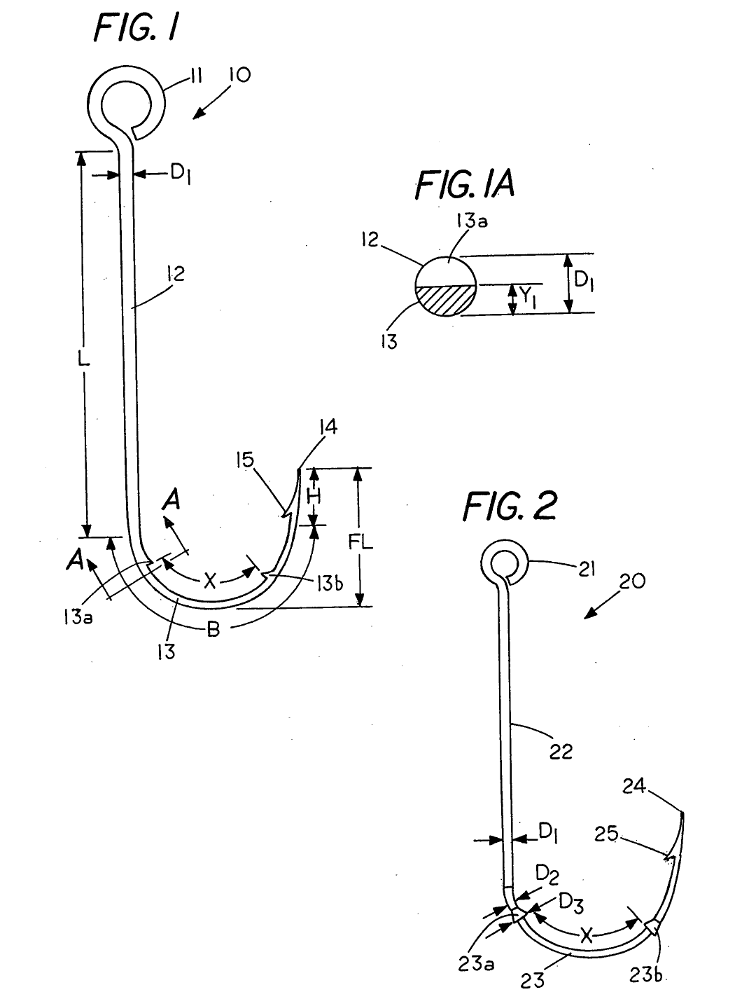

FIG. 2 shows an embodiment of a fishhook 20 with two cone shaped bend stops. Fishhook 20 comprises a shank 22 of diameter D₁ which tapers downward to a diameter D₂ at the tip of the cone 23a with the cone having a base with a diameter D₃ which larger than the diameter D₁ of the fishhook and a bait confining region 23 comprising a shank facing cone shaped stop 23b and a point facing cone shaped stop 23a. In the embodiment shown the stops 23b and 23a have been formed as a protrusion on the diameter with the bend stop 23b and the further bend 23a stop extending 360 degrees around the bend.

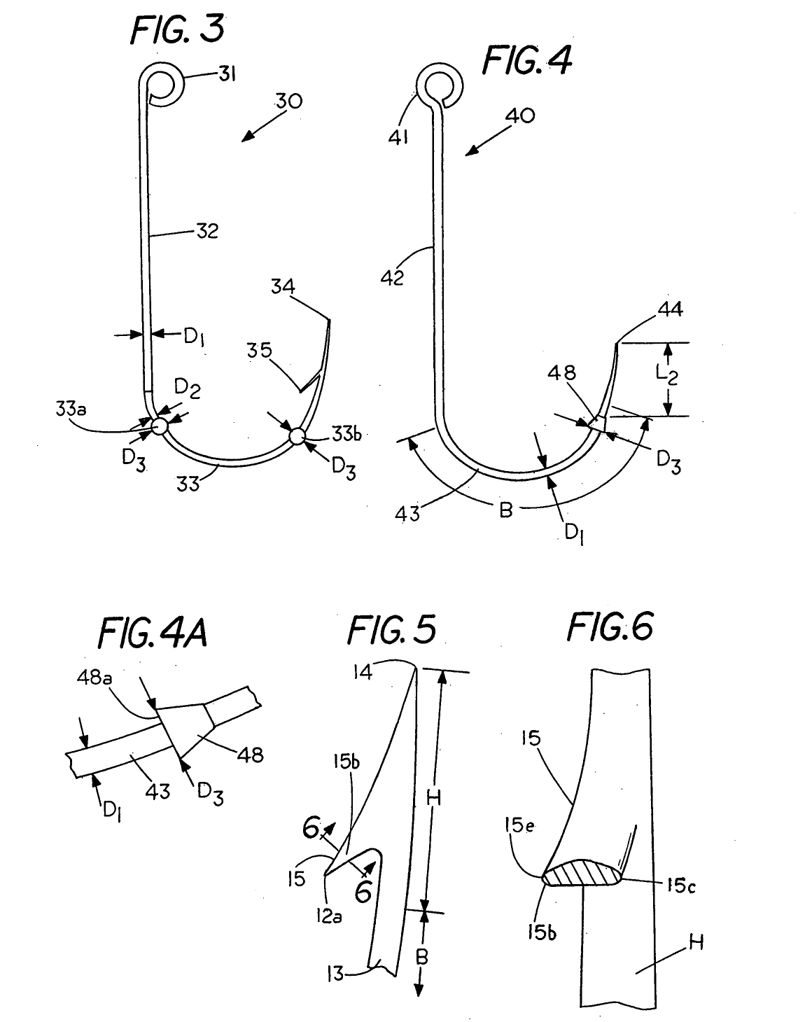

FIG. 3 shows a further embodiment of a fishhook 30 with two spherical shaped bend stops 33a and 33b forming a bait confiner 33b wherein the barb and the bend stop project inward substantially an equal amount to deter a fish from sliding along the bend and up to the barb. Fishhook 30 comprise a shank 32 of diameter D₁ with the bend stops having a diameter D₃ which is larger than the diameter D₁ of the shank 32 and a bait confiner 33c including stops 33a and 33b. In the embodiment shown the stops 33b and 33a have been formed as a protrusion on the peripheral surface of the fishhook and the bait confiner 33c is visually distinguishable from the rest of the fishhook by color as well as by shape. In this embodiment the shank 32 of the fishhook tapers down from a diameter D₁ to a diameter D₂ proximate the stop 33a. Thus the bend stop provides an inhibitor that inhibits a fish from “throwing the hook”.

Another embodiment of an inhibitor that inhibits a fish from throwing the hook is illustrated in FIG. 1, FIG. 5 and FIG. 6 which shows an enlarged view of head H of fishhook 10 revealing a barb 15 comprising a rounded non-cutting peripheral surface 15b and a barb point 15a. Conventional barbs on a fishhook are cut from the wire stock and include sharp corners or lateral edges that extend longitudinally along the length of the barb. FIG. 6 shows a cross sectional view taken along lines 6-6 to reveal the fishhook barb 15 does not have the lateral conventional sharp cutting edges. That is, while the barb point 12a can pierce a fish or the bait the lateral edges of the barb do not cut the flesh of the mouth of the fish since the conventional sharp edges of the barb 15 have been replaced with a rounded non cutting edge 15b and a rounded non-cutting edge 15c that extend along the length of the barb 15 so as to provide a non-cutting edge surface.

Thus. in one embodiment the inhibitor fishhook comprises a conventional fishhook without bend stops wherein the edges of the barb have been rounded so as to prevent the edges of the barb from cutting the mouth of the fish. In a further embodiment a fishhook with a sharp edge barb or a barbless fishhook can be used with a bend stop to inhibit a fish from “throwing the hook”. In still another embodiment the inhibiting features can be combined wherein a fishhook with a barb having non-cutting edges is used in conjunction with a bend stop or bend stops to enhance the ability of the fishhook to prevent a fish from throwing the fishhook.

Thus the invention comprises a fishhook to inhibit a fish from throwing a hook wherein the fishhook includes an inhibitor for preventing a fish from throwing the hook wherein the inhibitor is either a bend stop or a barb having a pair of longitudinally extending non-cutting edges.

While the invention is shown as use as a single hook it is envisioned that the invention can be used with multiple hooks on the same shank as well as with a trailer hook.

I claim:

1. A fishhook comprising:
a shank having an eye for attachment of a fishing line thereto;
a head having a point;
a bend connecting the shank to the head with the bend having a bend stop proximate the head to inhibit or prevent bait from sliding off the fishhook or a fish from throwing the fishhook.

2. The fishhook of claim 1 wherein the fishhook has a front length with the front length and the bend overlapping each other with the bend stop located on the overlapping of the front length and the bend.

3. The fishhook of claim 1 including a further bend stop spaced from the bend stop to form a bait confiner to limit movement of bait along the fishhook.

4. The fishhook of claim 3 wherein the bait confiner has a cross section area that is less than the cross section area of the shank of the fishhook and the bait confiner is visually distinguishable from the rest of the fishhook by color as well as by shape.

5. The fishhook of claim 1 wherein the bend stop comprises an annular cone shaped projection located on the bend of the fishhook with a base of the cone shaped projection forming a stop surface.

6. The fishhook of claim 1 wherein the bend stop comprises a spherical member having a diameter at least twice the diameter of the shank.

7. The fishhook of claim 1 wherein the head includes a barb wherein the barb and the bend stop project inward substantially an equal amount to deter a fish from sliding along the bend and up to the barb.

8. The fishhook of claim 3 wherein an inner radial portion of the bend which is located between the bend stop and the further bend stop has been removed by grinding to provide a bait confining region in the bait confiner.

9. The fishhook of claim 1 wherein the bend stop is press fit onto the fishhook.

10. The method of making a bait confiner fishhook comprising the steps:
bending an elongated member to form a bend therein;
forming a shank on one side of the bend;
forming a point on the other side of the bend; and
forming a bait confiner on the bend of the fishhook.

11. The method of claim 10 wherein the step of forming the bait confiner on the bend by comprises reducing the cross section of the bend by grinding away a portion of the bend to form the bait confiner.

12. The method of claim 10 wherein a radial extending stop is formed on a first end of the bait confiner.

13. The method of claim 10 wherein a radial extending stop is formed on a second end of the bait confiner.

14. The method of claim 10 wherein the bait confiner is formed along a portion of the bend of the hook.

15. The method of claim 10 wherein forming a bait retainer comprises removing material from an inside portion of the bend.

16. A fishhook to inhibit a fish from throwing a hook comprising;
a shank having an eye;
a head;
a bend intermediate the shank and the head; and
an inhibitor for preventing a fish from throwing the hook wherein the inhibitor is either a bend stop or a barb having a pair of longitudinally extending non-cutting edges.

17. The one-piece fishhook of claim 16 including a further bend stop located on the bend proximate the shank with a region extending from the further stop to the bend stop comprising a bait confiner that inhibits bait from sliding off the bend of the hook.

18. The one-piece fishhook of claim 16 wherein the bend stop and the further bend stop extend 360 degrees around the bend.

19. The one-piece fishhook of claim 15 wherein the bend stop includes an integral face extending radially inward toward a radius of curvature of the bend.

20. The one-piece fishhook of claim 15 including at least two bend stops located on said bend with the bend stops visually distinguishable by color as well as by shape.

21. The one-piece fishhook of claim 15 wherein the head includes a barb with a non-cutting edge surface.
